(19) United States
(12) Patent Application Publication
(10) Pub. No.: US 2017/0082541 A1
(43) Pub. Date: Mar. 23, 2017

(54) System For Measuring Concentration For A Chemical Fluid In Sprayer

(71) Applicant: CNH Industrial America LLC, New Holland, PA (US)

(72) Inventors: John Posselius, Ephrata, PA (US); Tim Stombaugh, Nicholasville, KY (US); Yongbo Wan, Dublin, OH (US)

(21) Appl. No.: 15/267,490

(22) Filed: Sep. 16, 2016

Related U.S. Application Data
(60) Provisional application No. 62/219,941, filed on Sep. 17, 2015.

(51) Int. Cl. G01N 21/59; A01M 7/00; A01C 23/00; B05B 15/00; B05B 12/08

(52) U.S. Cl. CPC G01N 21/59; B05B 15/002; B05B 12/08; A01C 23/007; A01M 7/0089; G01N 2201/062

(57) ABSTRACT

By measuring chemical concentrations of a crop protection fluid based on light transmission through the fluid, chemical concentrations may be determined and more effectively maintained during spray applications. A closed loop control system may be implemented to adjust the amount of chemical being metered based on the amount of light transmitted through the fluid such that an effective concentration may be continuously maintained without operator intervention.

### CROSS-REFERENCE TO RELATED APPLICATIONS

This is a non-provisional application based upon U.S. provisional patent application Ser. No 62/219,941. entitled “System for Measuring Concentration for a Chemical Fluid in Sprayer,” filed Sep. 17, 2015, which is incorporated herein by reference.

### FIELD OF THE INVENTION

The present invention relates generally to agricultural implements, and in particular, to a chemical concentration detection system for use with agricultural field sprayers.

### BACKGROUND OF THE INVENTION

Field sprayers, as known in the art, are typically attached to, or towed by, an agricultural implement, such as a tractor or other vehicle, or are a dedicated self-propelled sprayer vehicle. Such sprayers generally include a fluid holding tank supported by a frame. The fluid holding tank typically stores a crop protection fluid, such as pesticides or liquid fertilizer, which often consists of a carrier fluid such as water) mixed with a chemical at a predetermined concentration. The fluid holding tank, in turn, is fluidly coupled to a series of spray nozzles spaced apart from one another along booms extending outwardly from the frame. Accordingly, the crop protection fluid may be dispensed through the spray nozzles onto the farm field, preferably in an even distribution spray pattern, so that the fluid is applied consistently across the farm field.

When spraying or otherwise depositing fluids onto the field, it is important that the concentration of the chemical with respect to the carrier fluid be known and maintained. If there is too little chemical in the carrier fluid, then the resulting crop protection fluid might not provide the protection of the farm field desired. Conversely, if there is too much chemical in the carrier fluid, then the resulting crop protection fluid might harm the crops in the farm field,

What is needed is an improved system for spraying in which the concentration of the chemical with respect to the carrier fluid may be known and maintained, thereby achieving an effective level of protection for crops in the farm field.

### SUMMARY OF THE INVENTION

The inventors have recognized that light transmission may be used to measure chemical concentrations of a crop protection fluid so that chemical concentrations may be determined and more effectively maintained during spray applications. A closed loop control system may be implemented to adjust the amount of chemical being metered based on the amount of light transmitted through the fluid such that an effective concentration may be continuously maintained without operator intervention.

A direct injection system may be used in which a carrier fluid (which may be water) from a first tank is mixed with a chemical fluid from a second tank in a mixing chamber of each nozzle body or some other point between the carrier fluid tank and the nozzle body. The chemical fluid being injected into the mixing chamber may be controlled, though not necessarily at a constant rate, and the carrier fluid may be varied for variable application rates, turn compensation or other reasons. Alternatively, the carrier fluid may be controlled, though not necessarily at a constant rate, and the chemical fluid being injected into the mixing chamber may be varied for variable application rates, turn compensation or other reasons. As a result, a chemical application rate may be controlled to a desired target, and a record of the amount of chemical applied (based on the concentration of the solution) may be known.

In one aspect, the absorbance, reflection, or refraction level of light emitted from a light emitting diode (LED) may be sensed by a corresponding photodiode by corresponding reduction in transmission intensity, The reduced transmission level may then be correlated to the concentration rate of the chemical, such as in a nozzle body pre chamber. In another aspect, reflectance sensors could be provided in which a transmitter and a receiver are adjacent to one another and a measurement of energy reflected by the liquid is obtained.

Specifically then, one aspect of the present invention provides a concentration detection system for use with an agricultural sprayer including: a spray nozzle assembly providing first and second inlets for receiving first and second fluids, respectively, a mixing chamber for mixing the first and second fluids to provide a mixed fluid, and an outlet for spraying the mixed fluid; a light source connected to the spray nozzle assembly; and a light sensitive receiver connected to the spray nozzle assembly, the light sensitive receiver being operable to generate an electrical signal indicating an amount of light received by the light sensitive receiver. The light source may transmit light through the mixed fluid in the spray nozzle assembly to the light sensitive receiver, and the light sensitive receiver may generate the electrical signal indicating the amount of light received.

A controller may be operable to receive the electrical signal. The controller may be configured to determine a concentration of at least one of the first and second fluids with respect to the mixed fluid according to the electrical signal.

A metering system may meter at least one of the first and second fluids to the spray nozzle assembly. The metering system may be in communication with the controller, and the controller may adjust the metering system based on the determined concentration in order to reach a target concentration in a closed loop system.

Other aspects, objects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout.

FIG. 1 illustrates a pictorial view of a spraying system in accordance with the present invention;

FIG. 2 illustrates a pictorial view of a spray nozzle assembly in accordance with the present invention;

FIG. 3 illustrates an exploded pictorial view of an alternative spray nozzle assembly having the mixing body of FIG. 2, but with an alternative nozzle body and an alternative control valve, in accordance with the present invention;

FIG. 4A illustrates a pictorial view of a mixing body, and FIG. 4B illustrates a pictorial view of a flow control body, each in accordance with the present invention;

FIG. 5 illustrates a partial schematic view of a light source transmitting light through a mixed fluid to a light sensitive receiver in accordance with the present invention;

FIG. 6 illustrates an exemplar graph relating concentrations of fluids and variations of electrical signal output from the light sensitive receiver of FIG. 5 in accordance with the present invention;

FIG. 7 illustrates a schematic view of a controller in communication with a metering system and spray nozzle assemblies in accordance with the present invention; and

FIG. 8 illustrates a pictorial view of an alternative spraying system in accordance with the present invention.

### DETAILED DESCRIPTION OF THE DRAWINGS

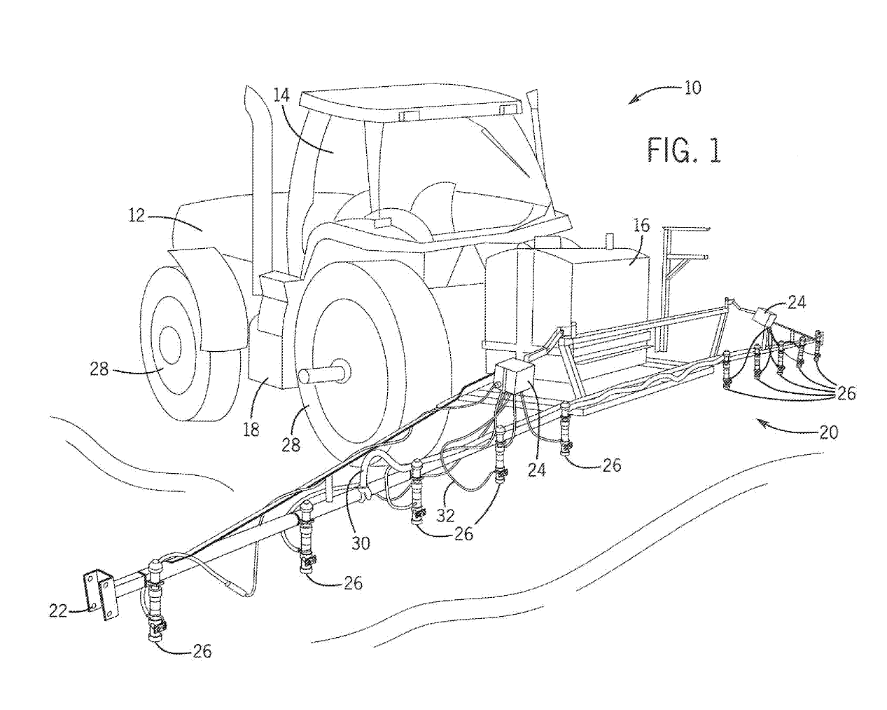

Referring generally to the drawings, and more particularly to FIG. 1, an exemplar agricultural product application system, which in the illustrated embodiment is a field spraying system 10 (a tractor with a three point mounted sprayer attached), is shown in accordance with the present invention. The field spraying system 10 may comprise a self-propelled sprayer 12 having an operator cab 14 and a primary fluid tank 16 supported by a chassis 18. A rear end 20 of the chassis 18 may support a wing boom 22 for multiple wing booms) to which one or more secondary fluid tanks, which could be provided as illustrated by reference numeral 24, may be supported. The wing boom 22 also supports a series of spray nozzle assemblies 26 for spraying an area of a field. The chassis 18 is supported by a set of wheels 28, and the wing boom 22, depending on size, may be supported by a set of smaller wheels (not shown).

Primary distribution lines 30 are flow coupled between the primary fluid tank 16 and the spray nozzle assemblies 26. The primary fluid tank 16 may typically store a carrier fluid such as water. The primary distribution lines 30 may provide flow of the carrier fluid to the spray nozzle assemblies 26 directly or indirectly, such as via one or more charge pumps, accumulators, control valves, pressure relief valves, manifolds and/or supplemental distribution lines in the path as understood in the art for effecting various flow rates, pressures and control for sprayer configurations.

Secondary distribution lines, which could be provided as illustrated by reference numeral 32, may be flow coupled between one or more of the secondary fluid tanks 24 and the spray nozzle assemblies 26. The secondary fluid tanks 24 may typically store a chemical fluid, such as a liquid fertilizer, pesticide, herbicide, or the like. The secondary distribution lines 32 may provide flow of the chemical fluid to the spray nozzle assemblies 26 directly or indirectly, such as via one or more charge pumps, accumulators, control valves, pressure relief valves, headers, manifolds and/or supplemental distribution lines in the path as understood in the art for effecting various flow rates, pressures and control for sprayer configurations. Accordingly, the carrier fluid and the chemical fluid may be stored in different tanks and subsequently mixed at each of the spray nozzle assemblies 26 thereby providing improved distribution in the field. The secondary fluid tanks 24 are typically smaller than the primary fluid tank 16.

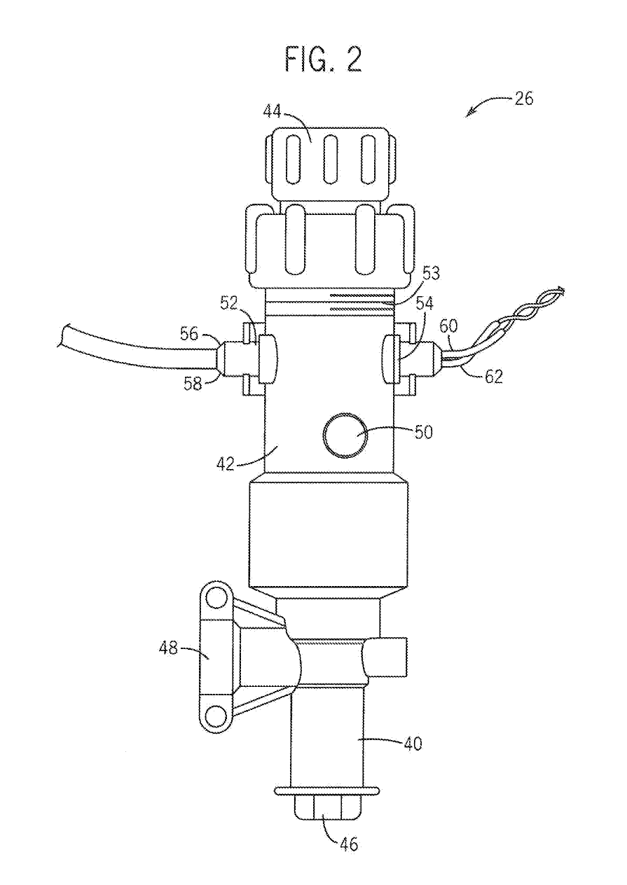

Referring now to FIG. 2, in a concentration detection system, a pictorial view of an exemplar spray nozzle assembly 26 is provided in accordance with the present invention. The spray nozzle assembly 26 may generally include a nozzle body 40, coupled in turn to a mixing body 42, coupled in turn to a control valve 44. In one aspect, the nozzle body 40 may be thread coupled to the mixing body 42, and the mixing body 42 may be thread coupled to the control valve 44, although other temporary or permanent coupling techniques known in the art could be used, such as pressure fittings and/or adhesive agents.

The nozzle body 40 includes a nozzle outlet 46 (orifice) for spraying a mixed fluid which will typically consist of a carrier fluid (such as water) mixed with a chemical fluid at some concentration. The nozzle body 40 may also include a nozzle body inlet 48 for receiving the carrier fluid. The carrier fluid may come from the primary fluid tank 16 via the primary distribution lines 30.

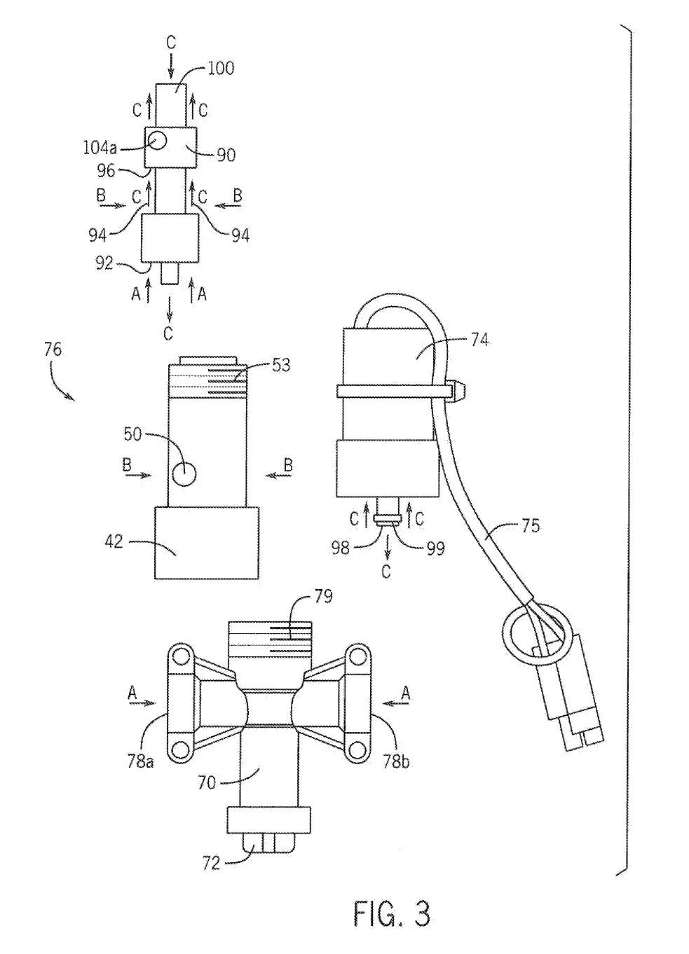

The mixing body 42 may include a mixing body inlet 50 for receiving the chemical fluid (such as a liquid fertilizer, pesticide, herbicide, or the like). The chemical fluid may come from either of the secondary fluid tanks 24 via the secondary distribution lines 32. Within the mixing body 42, a flow control mechanism (shown in FIG. 3) may provide a mixing chamber for mixing the carrier fluid with the chemical fluid in the nozzle to provide the mixed fluid.

The control valve 44 operates to stop the mixed fluid from flowing to the nozzle outlet 46, or to allow the mixed fluid to flow to the nozzle outlet 46 for spraying. The control valve 44 could be a passive check valve, as shown in FIG. 2, in which the mixed fluid is mechanically stopped from flowing if there is insufficient pressure applied by the mixed fluid against a valve mechanism, or the mixed fluid is allowed to flow if there is a build-up of sufficient pressure of the mixed fluid against the valve mechanism. Alternatively, the control valve 44 could be an actively controlled solenoid valve, as shown in FIG. 3 by reference numeral 74, in which the mixed fluid is stopped from flowing or allowed to flow depending on a control signal provided to a solenoid which actuates a valve. Accordingly, the control valve 44 may serve to prevent undesirable leaking of the mixed fluid. Also, the control valve 44 may be operator or computer controlled in the field.

Still referring to FIG. 2, a light source 52 and a light sensitive receiver 54 may each be connected to the spray nozzle assembly 26. The light source 52 and the light sensitive receiver 54 may be contained in separate housings, and each of the housings may fit in opposing openings of the mixing body 42 with fluid tight seals. The light source 52 may be any circuit, element or device for emitting light in the mixing body, and may preferably be a Light Emitting Diode (LED). First and second light source signals 56 and 58, respectively, may interface with other control systems or circuitry of the field spraying system 10 and may allow for turning on or off the light source 52, biasing, and/or controlling the intensity, brightness and/or wavelength of light produced by the light source 52.

The light sensitive receiver 54 may be any circuit element or device for receiving light in the mixing body and generating an electrical signal indicating an amount of light received by the light sensitive receiver 54. The light sensitive receiver 54 may preferably be a photodiode. In particular, the light sensitive receiver 54 may receive light from the light source 52 (passing through the mixed fluid) within the mixing body 42. First and second light sensitive receiver signals 60 and 62, respectively, may interface with other control systems or circuitry of the field spraying system 10 and may allow for sending an electrical signal indicating the amount of light received by the light sensitive receiver 54, biasing, and/or controlling the wavelength of light to which the light sensitive receiver 54 may be sensitive.

In sending the electrical signal indicating the amount of light received, one of the first and second light sensitive receiver signals 60 and 62, respectively, could be used to provide an analog voltage having a magnitude in proportion to the amount of light received by the light sensitive receiver 54, while the other of the first and second light sensitive receiver signals 60 and 62, respectively, could provide a reference level. In an alternative aspect, digital circuitry could be employed in the light sensitive receiver 54 so that the first and/or second light sensitive receiver signals 60 and/or 62, respectively, provide a digital representation of the magnitude of light received.

Referring now to FIG. 3, an exploded pictorial view of an alternative spray nozzle assembly 76 having the mixing body 42 of FIG. 2, but with an alternative nozzle body 70 and an alternative control valve 74, is provided in accordance with the present invention. In this aspect, the nozzle body 70 may include first and second nozzle body inlets 78a and 78b, respectively, for receiving the carrier fluid instead of a single nozzle inlet. Accordingly, the multiple inlets (the first and second nozzle body inlets 78a and 78b, respectively) may allow for alternative implementations of the spray nozzle assembly 76 in the field spraying system 10, such as ganging a plurality of spray nozzle assemblies 76 together. The nozzle body 70 may be coupled to the mixing body 42, for example, via nozzle body threading 79.

Also in this aspect, the control valve 74 is an actively controlled solenoid valve. Accordingly, mixed fluid is stopped from flowing or allowed to flow depending on a control signal provided, via wiring/interconnect 75, to a solenoid which controls the valve. The wiring/interconnect 75 may interface with other control systems or circuitry of the field spraying system 10 for control of spraying applications in the field. The control valve 74 may be coupled to the mixing body 42, for example, via mixing body threading 53. It will be appreciated that with this configuration, if desired, the mixing body 42 could be removed, and the control valve 74 coupled directly to the nozzle body 70, via nozzle body threading 79, to revert to a de-featured implementation.

Also in this aspect, the mixing body 42 of FIG. 2 is used. The mixing body 42 may include a mixing body inlet 50 (or alternatively first and second mixing body inlets) for receiving the chemical fluid.

Within the mixing body 42, a flow control mechanism 90 may be provided for directing fluid flow within the spray nozzle assembly 76. With additional reference to 4A, fluid flow is depicted by way of arrows reference characters. In particular, arrows with the reference character “A” denote flow of the carrier fluid; arrows with the reference character “B” denote flow of the chemical fluid; and arrows with the reference character “C” denote flow of the mixed fluid.

In operation, the carrier fluid A is received via the first and second nozzle body inlets 78a and 78b, respectively, of the nozzle body 70. The carrier fluid A is directed through a first interior opening 92 (which may be a plurality of openings) in the flow control mechanism 90, leading to a mixing chamber 94. The mixing chamber 94 may be defined by a cavity formed by exterior walls of the flow control mechanism 90 and interior walls of the mixing body 42.

The chemical fluid B is received via the mixing body inlet 50 of the mixing body 42. The chemical fluid B is directed to the mixing chamber 94, thereby mixing in the nozzle to form the mixed fluid C. The mixed fluid C, in turn, is directed through a second interior opening 96 (which may be a plurality of openings) in the flow control mechanism 90, leading to the control valve 74.

Upon sufficient pressure of the mixed fluid C, such as with a check valve, or upon actuation of the control valve 74, such as with the solenoid valve, the mixed fluid C will then flow through the control valve 74 and exit via a control valve outlet 98. The control valve outlet 98 is fluidly coupled with an interior channel 100 of the flow control mechanism 90 and may be fluid sealed with a sealing member 99. The mixed fluid C may then, in turn, travel through the interior channel 100 to an orifice 102 proximal to the nozzle outlet 72 of the nozzle body 70 for spraying.

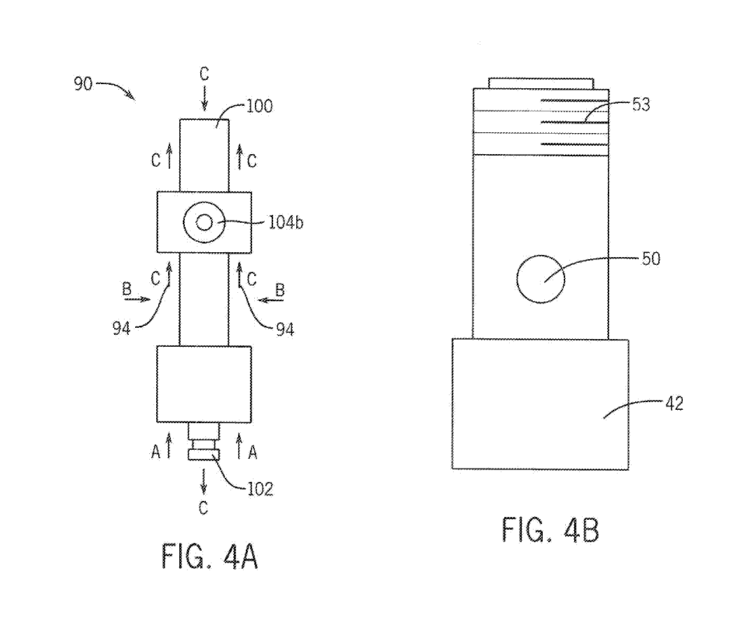

Still referring to FIGS. 3 and 4A, the mixing body includes first and second openings 104a and 104b, respectively, for accommodating the light source 52 and the light sensitive receiver 54 with fluid tight seals. In one aspect, the first openings 104a could receive the light source 52, and the second opening 104b could receive the light sensitive receiver 54, and the first and second openings 104a and 104b could be opposing such that a fluid inspection region 106 for transmitting light through the mixed fluid is formed in between. Transmission of light from the light source 52 to the light sensitive receiver 54, through the fluid inspection region 106, may allow determining a concentration of the chemical fluid in the mixed fluid by determining how much light is received by the light sensitive receiver 54 (and how much light is inhibited by the mixed fluid).

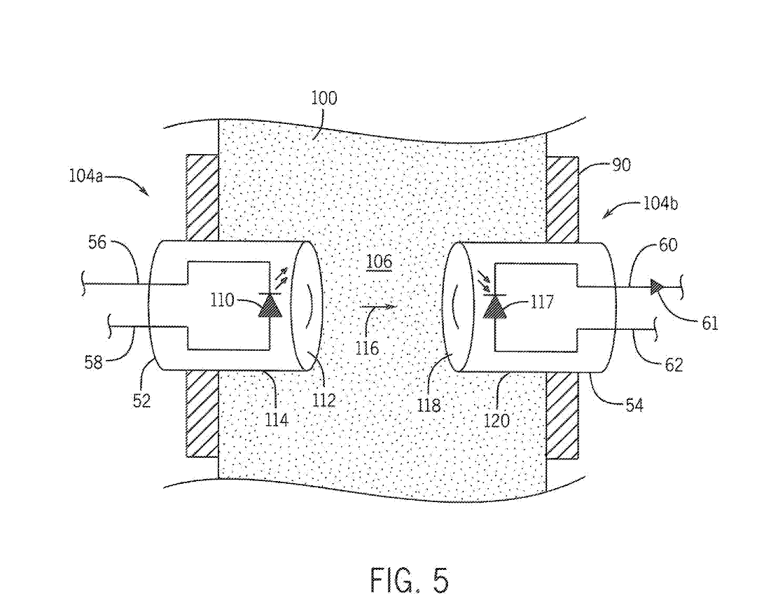

Referring now to FIG. 5, a partial schematic view of the light source 52 transmitting light through the mixed fluid C to the light sensitive receiver 54 is provided in accordance with the present invention. The light source 52 may comprise an LED 110 transmitting light through a lens 112 attached to a light source housing 114 of the light source 52. An amount of light 116, which may typically be less than the amount of light transmitted by the light source 52, is received through the mixed fluid in the fluid inspection region 106 by the light sensitive receiver 54 which may comprise a photodiode 117. The light 116 may be received through a lens 118 attached to a light sensitive receiver housing 120 of the light sensitive receiver 54. The light sensitive receiver 54, in turn, generates an electrical signal 61 indicating the amount of light received, such as via the first light sensitive receiver signal 60.

A predetermined tracer dye may also be added to the chemical fluid for improved results. The presence or absence of tracer dye in the chemical fluid, and the amount of the tracer dye being used may vary depending on the type of chemical fluid being used. Accordingly, a calibration measurement may be recorded for each fluid mixture to reflect a target concentration of the mixed fluid.

The lens 112 may be coupled to the light source 52 via the light source housing 114 and may be operable to focus light in the direction of the light sensitive receiver 54. Similarly, the lens 118 may be coupled to the light sensitive receiver 54 and may also be operable to focus light in the direction of the light sensitive receiver 54.

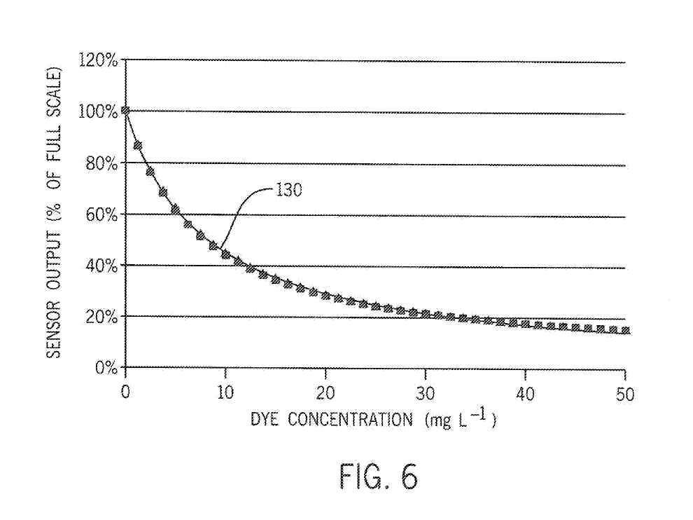

Referring now to FIG. 6, an exemplar graph 130 relating concentrations of mixed fluids and variations of the electrical signal 61 output from the light sensitive receiver 54 is provided in accordance with the present invention. The horizontal axis (or Cartesian “x-axis”) of the graph 130 reflects various tracer dye concentrations levels in milligrams per Liter, which reflects the concentration of chemical in mixed fluid. The vertical axis for Cartesian “y-axis”) of the graph 130 reflects various output levels of the light sensitive receiver 54 (or sensor), which may reflect the analog voltage variation of the electrical signal 61.

With a concentration of zero chemical in mixed fluid, the light sensitive receiver 54 may receive full light and provide a full, strength output of 100% (which may be a peak voltage level for the electrical signal 61). This may also define a calibration point in the concentration detection system. As the concentration of chemical in the mixed fluid rises, the light sensitive receiver 54 may receive less light and provide an output of decreasing strength (which may be less than the peak voltage level for the electrical signal 61). As the concentration of chemical in the mixed fluid approaches an exceedingly high quantity, the light sensitive receiver 54 may receive limited light and provide a weak output (which may be a low voltage level for the electrical signal 61). Depending on the tracer dye or chemical fluid, it may be possible to reach a concentration of chemical in the mixed fluid such that the light sensitive receiver 54 receives no light and, as a result, provides no electrical output.

Accordingly, an increasing amount of chemical fluid, as indicated by tracer dye, in the mixed fluid may increasingly inhibit light from transmitting through the mixed fluid to the light sensitive receiver 54. Conversely, a decreasing amount of chemical fluid, as indicated by tracer dye, may decreasingly inhibit the amount of light transmitting through the mixed fluid to the light sensitive receiver 54.

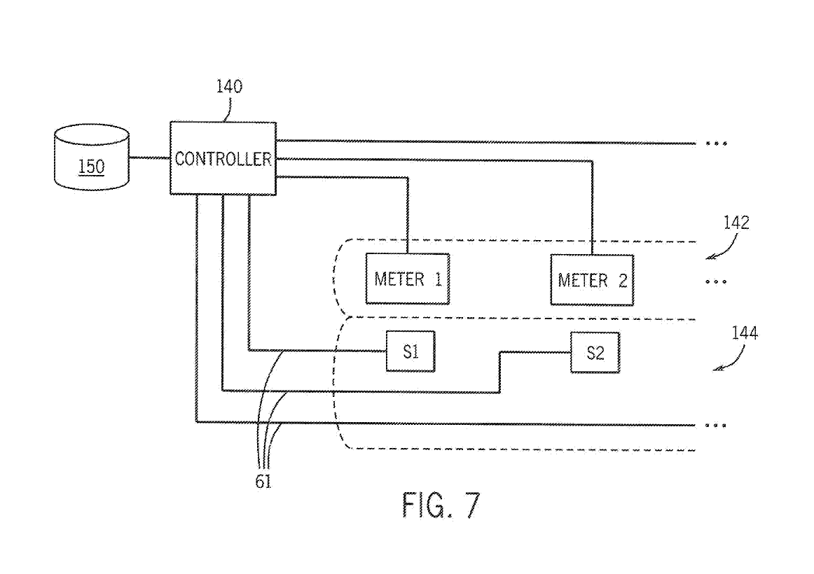

Referring now to FIG. 7, a schematic view of a controller 140 in communication with a metering system 142 and spray nozzle assemblies 144 is provided in accordance with the present invention. The metering system 142 may include one or more meters for metering, or controlling the amount of, chemical fluid provided to corresponding spray nozzle assemblies 144, thereby controlling concentration of chemical in the mixed fluid. However, it will be appreciated that in an alternative aspect, the metering system 142 could include one or more meters for metering, or controlling the amount of, carrier fluid provided to corresponding spray nozzle assemblies 144 to control the concentration of chemical in the mixed fluid by effecting dilution. Accordingly, the controller 140 is configured to adjust the metering system 142 to adjust concentration, and the controller 140 is configured to receive feedback with regard to the concentration based on via receiving the electrical signals 61 from the light sensitive receivers of the spray nozzle assemblies 144. The controller 140 may be a microprocessor, a microcontroller or other programmable logic element as known the art.

The controller 140 may receive a target concentration for the chemical fluid. The controller 140 may then implement a closed loop system in order to reach the target concentration. For example, the controller 140 may iteratively adjust the metering system 142, and receive feedback via the electrical signals 61 from each of the spray nozzle assemblies 1144 reflecting spray nozzle concentrations, in order to reach and maintain the target concentration. The controller may also implement any portion of Proportional-Integral-Derivative (PID) control in the closed loop system, collectively or individually for the spray nozzle assemblies 144, in order to reach the target concentration. The controller 140 may also communicate with a database 150 for storing, among other things, calibration data, predetermined concentrations for chemical fluids, and the like.

In another aspect, the controller 140 may be configured to turn on or off the spray nozzle assemblies 144, such as via solenoid control valves. The controller 140 could turn off the spray nozzle assemblies 144 if a target concentration is unable to be achieved in the spray nozzle assemblies 144 within a predetermined amount of time. The controller 140 could also turn on or off the spray nozzle assemblies 144 according to a current position of the field spraying system 10, as detected by a Global Positioning System (GPS) or other locating system, with respect to a field map which may be stored in the database 150. For example, the controller 140 could turn off the spray nozzle assemblies 144 upon determining that the field spraying system 10 has left the treatment area, and/or turn on the spray nozzle assemblies 144 upon determining that the field spraying system 10 has returned to the treatment area.

In another aspect, the controller 140 may be configured to send an audible and/or visual alert to the operator in the cab 14 in accordance with one of the foregoing conditions. For example, the controller 140 could generate an audible and/or visual alert to the operator in the cab 14 if a target concentration is unable to be achieved in the spray nozzle assemblies 144 within a predetermined amount of time.

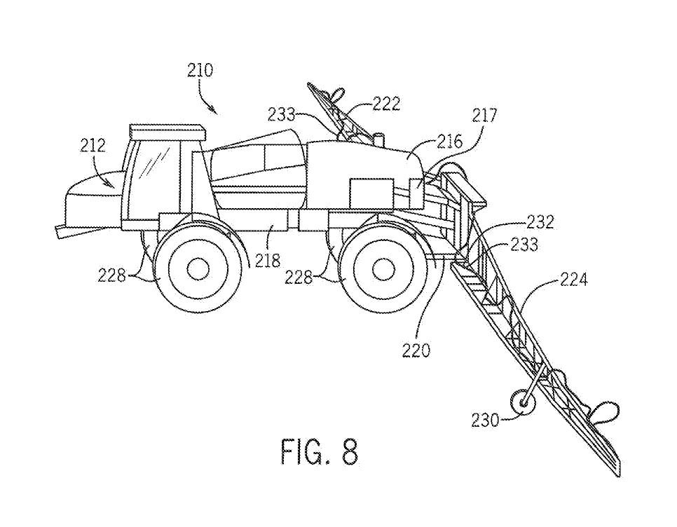

Referring now to FIG. 8, a pictorial view of an alternative spraying system is provided in accordance with the present invention. A field spraying system 210 may be comprised of a self-propelled sprayer 212 having primary and secondary fluid tanks 216 and 217, respectively, that are supported by a chassis 218 in a known manner. As also known in the art, a rear end 220 of the chassis 218 may supports a pair of wing booms 222, 224 to which a series of the spray nozzle assemblies (not shown) may be coupled. The chassis 218 may be supported by a set of tires 228, and the wing booms may be supported by smaller wheels 230. Primary and secondary distribution lines 232 and 233, respectively, may be flow coupled to the primary and secondary fluid tanks 216 and 217, respectively, in order to provide field spraying capability similar to the field spraying system 10 described above with respect to FIG. 1

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

By way of example, although described in the context of sprayers applying a crop protection fluid, it will be appreciated that many other types of mixtures and applications may he made within the scope of the present invention. Also, although described generally in the context of a nozzle body receiving a carrier fluid and a mixing body receiving a chemical fluid, it will be appreciated that many other configurations may be possible, such as the nozzle body receiving the chemical fluid or both fluids, the mixing body receiving the carrier fluid or both fluids, multiple inlets in the nozzle body and the mixing body for either type of fluid, and/or greater integration between the nozzle body and the mixing body.

What is claimed is:

1. A concentration detection system for use with an agricultural sprayer comprising:
a spray nozzle assembly providing first and second inlets for receiving first and second fluids, respectively, a mixing chamber for mixing the first and second fluids to provide a mixed fluid, and an outlet for spraying the mixed fluid;
a light source connected to the spray nozzle assembly; and
a light sensitive receiver connected to the spray nozzle assembly, the light sensitive receiver being operable to generate an electrical signal indicating an amount of light received by the light sensitive receiver,
wherein the light source transmits light through the mixed fluid in the spray nozzle assembly to the light sensitive receiver, and the light sensitive receiver generates the electrical signal indicating the amount of light received.

2. The concentration detection system of claim 1, further comprising a controller operable to receive the electrical signal, the controller being configured to determine a concentration of at least one of the first and second fluids with respect to the mixed fluid according to the electrical signal.

3. The concentration detection system of claim 2, further comprising a metering system for metering at least one of the first and second fluids to the spray nozzle assembly, wherein the metering system is in communication with the controller.

4. The concentration detection system of claim 3, further comprising the controller being configured to adjust the metering system based on the determined concentration in order to reach a target concentration in a closed loop system.

5. The concentration detection system of claim 4, wherein the controller implements Proportional-Integral-Derivative (PID) control in the closed loop system.

6. The concentration detection system of claim 1, wherein the light sensitive receiver generates the electrical signal in response to a tuned wavelength of light.

7. The concentration detection system of claim 2, wherein the controller is in communication with a database relating concentrations of at least one of the first and second fluids with respect to the mixed fluid and variations of the electrical signal.

8. The concentration detection system of claim 1, further comprising a lens coupled to at least one of the light source and the light sensitive receiver operable to focus light in a direction of the light sensitive receiver.

9. The concentration detection system of claim 1, wherein the light source is a Light Emitting Diode (LED).

10. The concentration detection system of claim 1, wherein the light sensitive receiver is a photodiode.

11. A self-propelled sprayer comprising:
a chassis;
primary and secondary fluid tanks supported by the chassis;
a primary distribution line in communication with the primary fluid tank for distributing a first fluid;
a secondary distribution line in communication with the secondary fluid tank for distributing a second fluid;
a wing boom supported by the chassis, the wing boom having a plurality of spray nozzle assemblies, each spray nozzle assembly providing first and second inlets for receiving first and second fluids, respectively, a mixing chamber for mixing the first and second fluids to provide a mixed fluid, and an outlet for spraying the mixed fluid;
a plurality of light sources, each light source connected to a spray nozzle assembly; and
a plurality of light sensitive receivers, each light sensitive receiver connected to a spray nozzle assembly, each light sensitive receiver being operable to generate an electrical signal indicating an amount of light received by the light sensitive receiver,
wherein each light source transmits light through a mixed fluid in a spray nozzle assembly to a light sensitive receiver, and the light sensitive receiver generates an electrical signal indicating the amount of light received.

12. The self-propelled sprayer of claim 11, further comprising a controller operable to receive electrical signals from the light sensitive receivers, the controller being configured to determine concentrations of at least one of the first and second fluids with respect to the mixed fluid according to the electrical signals.

13. The self-propelled sprayer of claim 12, further comprising a metering system for metering at least one of the first and second fluids to the spray, nozzle assemblies, wherein the metering system is in communication with the controller.

14. The self-propelled sprayer of claim 13, further comprising the controller being configured to adjust the metering system based on a determined concentration in order to reach a target concentration in a closed loop system.

15. The self-propelled sprayer of claim 14, wherein the controller implements Proportional-Integral-Derivative (PID) control in the closed loop system.

16. The self-propelled sprayer of claim 11, wherein the light sensitive receivers generate the electrical signals in response to tuned wavelengths of light.

17. The self-propelled sprayer of claim 12, wherein the controller is in communication with a database relating concentrations of at least one of the first and second fluids with respect to the mixed fluid and variations of an electrical signal.

18. The self-propelled sprayer of claim 11, further comprising lenses coupled to at least one of the light sources and the light sensitive receivers operable to focus light in a direction of the light sensitive receivers.

19. The self-propelled sprayer of claim Ii, wherein the light sources are a Light Emitting Diodes (LED's).

20. The self-propelled sprayer of claim 11, wherein the light sensitive receivers are photodiodes.
